(19) United States
(12) Patent Application Publication
(10) Pub. No.: US 2024/0298858 A1
(43) Pub. Date: Sep. 12, 2024

(54) VENTILATION UNIT FOR A SUCTION DEVICE, METHOD FOR VENTILATING A SUCTION DEVICE, SUCTION DEVICE, AND USE OF AN AIR FLOW FOR DEDUSTING A FILTER OF THE SUCTION DEVICE

(71) Applicant: HILTI AKTIENGESELLSCHAFT, Schaan (LI)

(72) Inventor: Oliver OHLENDORF, Landsberg (DE)

(21) Appl. No.: 18/277,391

(22) PCT Filed: Feb. 18, 2022
(86) PCT No.: PCT/EP2022/054061

§ 371 Date: Aug. 16, 2023

(30) Foreign Application Priority Data
Mar. 3, 2021 (EP) 21160460.8

(51) Int. Cl. A47L 9/20; B01D 46/71

(52) U.S. Cl. CPC A47L 9/20; B01D 46/71; B01D 2279/55

(57) ABSTRACT

A ventilation unit for a suction device, wherein the ventilation unit is designed to let an air flow into an interior of the suction device, wherein the ventilation unit has a first sliding element and a second sliding element which are connected by a connecting element, wherein the first sliding element, the second sliding element and the connecting element form an active unit which is able to be brought from a closed position into an open position, and vice versa, by an actuator. A method for ventilating a suction device with a ventilation unit, wherein first of all a suction device having a ventilation unit is provided, the active unit of which is in a closed position. By actuation of the actuator, the active unit is brought into an open position such that the interior of the ventilation unit and/or of the suction device can be ventilated by an air flow which can pass into the interior of the ventilation unit and/or of the suction device through a first opening, exposed by a first sliding element, of the ventilation unit. In further aspects, the invention relates to the use of an air flow, which can be conducted into the interior of a suction device in particular to dedust a filter of the suction device using at least one ventilation unit.

The present invention relates to a ventilation unit for a suction device, wherein the ventilation unit is designed to let an air flow into an interior of the suction device. In further aspects, the invention relates to the use of an air flow, which can be conducted into the interior of a suction device using a ventilation unit, and to a suction device having a ventilation unit.

### BACKGROUND OF THE INVENTION

The prior art discloses suction devices, such as vacuum cleaners, which have filters that regularly need to be dedusted. Otherwise, the filters may become clogged with the result that operation with the suction device is no longer possible. Clogged filters can also have the effect of reducing the filtering capacity of the filter and dust and contaminants can enter the region of the sensitive components of the suction device, such as the turbine or motor. Therefore, there is a need to provide technical solutions for dedusting filters in suction devices.

### SUMMARY OF THE INVENTION

The prior art discloses for example mechanical methods for filter dedusting, in which the filters are tapped. These mechanical loads can result in undesired shaking of the entire suction device, however, and this can damage sensitive components of the suction device.

Furthermore, the prior art discloses backflushing methods for filter dedusting, in which the at least one filter is passed through by a dedusting air flow during filter dedusting, wherein the dedusting air flow is preferably directed counter to the suction air flow of the suction device. During the backflushing of filters in suction devices, in order to maintain continuous suction operation, work is frequently carried out with two filters and two filter chambers, which can be dedusted alternately such that suction operation of the suction device can always be continued with at least one chamber. A drawback of these known solutions, however, is that they generally take up a large amount of space and prevent small, compact suction devices from being able to be provided.

An object of the present invention is to overcome the above-described defects and drawbacks of the prior art and of providing a ventilation unit for a suction device, with which small, compact suction devices can be produced. Furthermore or alternatively, the ventilation unit to be provided should have low energy consumption and require little servicing.

According to the invention, a ventilation unit for a suction device is provided, wherein the ventilation unit is designed to let an air flow into an interior of the suction device. The ventilation unit has a first sliding element and a second sliding element which are connected by a connecting element, wherein the first sliding element, the second sliding element and the connecting element form an active unit which is able to be brought from a closed position into an open position, and vice versa, by an actuator.

For the purposes of the invention, the transfer of the active unit from the closed position into the open position is referred to preferably as “opening the ventilation unit”. For the purposes of the invention, the letting of the air flow into the interior of the ventilation unit and/or into the interior of the suction device is referred to preferably as ventilation. For the purposes of the invention, it is particularly preferred that the opening of the ventilation unit generates an air flow that can flow into a negative-pressure region of the suction device. The negative-pressure region of the suction device is preferably the interior of the suction device, which is subjected to negative pressure during operation of the suction device, wherein the negative pressure is used to suck in dust or contaminants. As a result of the negative pressure, an air flow is preferably generated, with which the contaminants can be sucked into the interior of the suction device. For the purposes of the invention, this air flow is referred to preferably as the suction air flow. Preferably, during suction operation of the suction device, there is a pressure difference between the interior of the suction device and the environment of the suction device, wherein in particular atmospheric pressure prevails in the environment of the suction device.

When the ventilation unit is opened, as a result of the pressure difference between the atmosphere and the interior of the suction device, the air is sucked highly dynamically into the interior of the suction device. For the purposes of the invention, the accelerated air flow can preferably also be referred to as a ventilation air flow. It passes into the interior of the suction device and can be conducted in particular in the direction of a filter element, of a dedusting unit or of a filter of the suction device. Suction devices have filters in order to protect sensitive components of the suction device, such as the turbine or the motor, from contaminants and dust. For the purposes of the invention, it is preferred that the air flow generated with the ventilation unit directly or indirectly brings about dedusting of the filter. This can take place for example by backflushing the filter or pressure-shock dedusting.

Preferably, the ventilation unit is integrated in a suction device. In other words, the ventilation unit can form a module that is integrated in a suction device for the ventilation thereof. The ventilation unit can have at least one open side, wherein this open side of the ventilation unit can be connected to an interior or to the negative-pressure region of the suction device. Preferably, during operation of the suction device, negative pressure prevails in the device or in the negative-pressure region thereof. This negative pressure can be generated for example by a turbine that can be driven by a motor. Outside the ventilation unit, or outside the suction device, preferably atmospheric pressure prevails. Those skilled in the art know that this atmospheric pressure is about 1.013 hPa or undergoes slight fluctuations. For the purposes of the invention, it is preferred that the interior of the ventilation device and the interior of the suction device are connected together.

The ventilation unit has a first sliding element and a second sliding element, wherein the sliding elements are preferably operatively connected by the connecting element. The connecting element is preferably designed to connect the sliding elements together such that an active unit is formed. The ventilation unit furthermore comprises an actuator which is designed to bring the active unit from a closed position into an open position (“opening of the ventilation unit” or “ventilation”). Of course, the actuator is also designed to bring the active unit from an open position into a closed position.

For the purposes of the invention, it is preferred that the first sliding element of the ventilation device acts as an inlet slide and the second sliding element acts as a compensation slide. In other words, the ventilation air flow can be let into the interior of the ventilation unit or of the suction device by the inlet slide. For the purposes of the invention, it is preferred for the first sliding element also to be referred to as first slide or first slide element, while the second sliding element can preferably also be referred to as second slide or second slide element.

For the purposes of the invention, it is preferred that the actuator is designed to move the active unit of the ventilation unit to and fro with a lateral movement. This lateral movement can also be referred to as a sideways movement. As a result of this lateral displacement of the active unit, which is advantageously brought about by the actuator, the first opening of the ventilation unit can be opened or closed on the inlet slide side. This advantageously has the result that, in the open position of the active unit, a ventilation air flow can pass into the interior of the ventilation unit and can bring about a dedusting process of the at least one filter of the suction device. On the side of the ventilation unit on which the compensation slide of the active unit is arranged, it is advantageously possible, as a result of the cooperation of the compensation slide with an elastic membrane, for the volume of the interior of the ventilation unit to be altered. Of course, in the context of the present invention, it is additionally or alternatively possible for other sealing solutions also to be employed. For example O-rings or sealing lips are possible, without the invention being limited thereto.

For the illustration of an exemplary embodiment of the invention, in the following text, the side of the ventilation unit on which the first slide is arranged is referred to as the left-hand side of the ventilation unit, while the compensation-slide side is referred to as the right-hand side of the ventilation unit. For the purposes of the invention, it is preferred that the left-hand side of the ventilation unit has a first opening, while the righthand side of the ventilation unit has a second opening. The first opening of the ventilation unit preferably cooperates with the first sliding element, while the second opening cooperates with the second sliding element.

In a second aspect, the invention relates to a method for ventilating a suction device with a ventilation unit, wherein the method is characterized by the following steps:
a) providing a suction device having a ventilation unit, wherein the active unit is in a closed position,
b) actuating the actuator such that the active unit is brought into an open position by the actuator,
c) ventilating an interior of the ventilation unit and/or of the suction device by way of an air flow which can pass into the interior of the ventilation unit and/or of the suction device through a first opening, exposed by a first sliding element, of the ventilation unit.

The terms, definitions and technical advantages introduced for the ventilation unit apply preferably in an analogous manner to the ventilation method, the suction device and the use of the air flow for dedusting a filter of the suction device. The active unit is initially in a closed position. In this closed position of the active unit, preferably no air flow through the ventilation unit is provided and the suction device can carry out suction operation in which dust is sucked in.

The closed position of the active unit is preferably characterized in that the first slide, or its closure element, covers the first opening of the ventilation unit. As a result, the first opening of the ventilation unit is closed. The closure or covering of the first opening by preferably the upper bar of the first sliding element can be improved further by the provision of sealing elements between a housing of the ventilation unit and the first sliding element. For the purposes of the invention, it is preferred that, in the interior of the ventilation unit, a large enough air volume is present for a dynamic air exchange to be able to be allowed by opening the first opening of the ventilation unit.

For the purposes of the invention, it is preferred that, in a preferred configuration of the invention, the second slide ends substantially flush with a housing of the ventilation unit. This preferably means, for the purposes of the invention, that an elastic element that can be connected to the upper region of the second sliding element bears flat against an outer side of the ventilation unit and, together with the second slide, closes off the second opening of the ventilation unit. Furthermore, for the purposes of the invention, it is preferred that the upper bar of the preferably T-shaped second sliding element is smaller than the second opening of the ventilation unit. As a result, the upper bar can be guided through the second opening until the second opening is closed off in a substantially flush manner. As a result of the actuator being activated, the active unit can be moved for example in a spatial direction to the left. During this lateral movement of the active unit in the spatial direction to the left, the active unit is advantageously transferred from the closed position into the open position. For the purposes of the invention, it is particularly preferred that the actuator brings the active unit into the open position by way of a lateral sideways movement. Preferably, the elastic element is made to bulge by the sideways movement of the active unit, wherein the bulge is concave with regard to the interior of the ventilation unit. This means that the bulge of the elastic element of this configuration of the invention points into the interior of the ventilation unit such that the deepest point of the elastic element is located in the interior of the ventilation unit. The preferably concave bulge of the elastic element can be achieved in particular in that the elastic element is at least partially connected to the upper bar of the second sliding element such that it is moved conjointly to the left by the sideways movement of the active unit or of the second slide. This movement “to the left” preferably brings about the bulge, extending into the interior of the ventilation unit, of the elastic element. For the purposes of the invention, it is preferred that, as a result of the elastic deformation of the elastic element, additional mechanical solutions to the to and fro movement of the active unit are not necessary. For example, the elastic properties of the elastic element, which is preferably in the form of an elastomer membrane, can be used to bring the active unit from the closed state into the open state of the ventilation unit.

In an alternative configuration of the invention, it is preferred that the second slide, in the closed state, projects or protrudes a short distance s beyond the housing of the ventilation unit. This protrusion of the second slide beyond the housing of the ventilation unit becomes possible in that the upper bar of the preferably T-shaped second sliding element is smaller than the second opening of the ventilation unit. As a result, the upper bar can be guided or slide through the second opening and stretch the elastic element. As a result of the actuator being activated, the active unit can be moved for example in a spatial direction to the left. During this lateral movement of the active unit in the spatial direction to the left, the active unit is advantageously transferred from the closed position into the open position. For the purposes of the invention, it is particularly preferred that the actuator brings the active unit into the open position by way of a lateral sideways movement.

In the open position, on the inlet side of the ventilation unit, which is preferably referred to as the left-hand side of the ventilation unit, the first opening is opened in that it is exposed by the first sliding element. For the purposes of the invention, it is preferred that, between the first slide and the housing of the ventilation unit, gaps are formed, through which air can pass into the interior of the ventilation unit or of the suction device. This entering air preferably forms the ventilation air flow, with which the at least one filter or a dedusting unit of the suction device can be backflushed or flushed. The movement, brought about by the actuator, of the active unit in a spatial direction to the left has the result, on the right-hand side of the ventilation unit, that the second slide likewise moves to the left, with the result that the protrusion of the second sliding element is eliminated. At the end of the lateral movement of the active unit, the protrusion of the compensation slide has been eliminated more or less entirely and the upper bar of the second slide preferably no longer protrudes beyond the housing of the ventilation unit. As a result, the elastic element can rest more or less fully on the outer side of the ventilation unit or on the upper bar of the second slide. In this open position of the active unit, too, the second opening remains closed by the second slide and the elastic element.

For the purposes of the invention, it is preferred that the actuator comprises an electromagnetic lifting magnet. Preferably, the actuator can cooperate with the connecting element of the active unit such that activation of the actuator causes or brings about a movement of the active unit. The actuator may comprise for example a hollow interior in which the connecting means is guided. The connecting element of the active unit may be for example rigid and/or in the form of a push rod. For the purposes of the invention, it is preferred that, with the actuator, an opening force can be generated with which the active unit can be displaced laterally such that the first sliding element is lifted off the first opening of the ventilation unit and in this way the first opening is exposed. Air from the environment of the suction device and preferably under atmospheric pressure then flows highly dynamically into the ventilation unit, wherein the interior of the ventilation unit is preferably fluidically connected to the at least one filter of the suction device. The filter can be dedusted by the air flowing in, wherein the ventilation air flow can be used for example to carry out membrane filter dedusting, to carry out pressure-shock filter dedusting or to carry out backflushing filter dedusting, without the invention being limited thereto.

Of course, it is additionally or alternatively possible for other types of actuators also to be used in the ventilation unit. For example, a manually actuable actuator can be used. A pneumatic lifting cylinder is also conceivable, for example, in order to move the active unit.

For the purposes of the invention, it is preferred that the actuator is energized when filter dedusting is intended to be carried out. If the actuator is in the form of an electromagnetic lifting magnet, the energization advantageously brings about a magnetic field with which the active unit can be moved. To close the inlet slide, the polarity of the actuator can be reversed. Alternatively, the energization can be ended or its polarity can be reversed or a spring element or the elastic properties of the elastic element can be exploited in order to close the ventilation unit or its first opening again. As a result of the ventilation unit being closed, the ventilation air flow is brought to a stop and the dedusting of the at least one filter of the suction device is ended. For the purposes of the invention, it is preferred that a tension spring can be arranged between the first sliding element and the actuator, wherein the opening or closing of the ventilation unit or its first opening can be made much easier with the tension spring. In particular, the tensioning forces of the spring can be used to make it easier to open or close the ventilation unit.

A significant advantage of the invention is that, to move the active unit, in particular to open the ventilation unit, the actuator has to apply only a small force or to overcome only small opposing forces. These opposing forces are in particular frictional forces or flexing forces that are inherent to the elastic element. As a result, a particularly compact and energy-efficient actuator can be used. When the ventilation unit is used in a battery-operated suction device, the run time of the rechargeable battery can advantageously be increased by the invention. In the case of grid operation, the energy consumption is reduced, as are the operating costs of the device. Preferably, the ventilation unit requires less installation space than comparable conventional units that are known from the prior art. As a result, the suction device can be produced as a whole in a compact and volume-optimized manner.

For the purposes of the invention, it is preferred that the ventilation unit has a first opening which is closable by the first sliding element. For the purposes of the invention, it is particularly preferred that the first opening of the ventilation unit is closed by the first slide primarily in the closed position of the active unit, while the first opening of the ventilation unit is exposed by the first slide in the open position of the active unit, such that the ventilation air flow can pass into the interior of the suction device. The entry of the ventilation air flow is promoted advantageously by the pressure difference that exists between the environment of the suction device and the interior of the suction device during operation of the suction device. Therefore, in the context of the present invention, the ventilation air flow is also said to be sucked in. Preferably, the first opening of the ventilation unit can be closed by the first slide in the closed position of the active unit. To this end, the first slide can be for example T-shaped, wherein the upper bar of the preferably T-shaped first slide can have a larger area than the first opening of the ventilation unit and in this way can cover and close the opening. The lower region of the preferably T-shaped first slide projects preferably into the interior of the ventilation unit and forms the transition to the connecting element.

For the purposes of the invention, it is preferred that the upper bar of the preferably T-shaped first slide is arranged on an outer side of the ventilation unit. In other words, it is preferred that the first slide covers or seals off the ventilation unit in the direction of an environment of the suction device. The upper bar of the preferably T-shaped first slide can preferably be referred to as a closure element.

For the purposes of the invention, it is preferred that the first sliding element has a first active surface, which corresponds substantially to a size of the first opening of the ventilation unit.

For the purposes of the invention, it is preferred that the upper bar of the preferably T-shaped first slide is larger than the first opening of the ventilation unit. Preferably, the area of this closure element corresponds to the active surface of the first slide, with which the first opening of the ventilation unit is covered or closed.

For the purposes of the invention, it is preferred that the ventilation unit has a second opening. Preferably, the second opening of the ventilation unit can be closed by the second sliding element in conjunction with an elastic element. For the purposes of the invention, it is preferred that the first opening and the second opening are arranged on opposite side walls of the ventilation unit. This preferably means, for the purposes of the invention, that the first and the second opening are arranged on opposite sides of the ventilation unit. Preferably, the openings represent openings in the housing of the ventilation unit, wherein the second opening is closed in all operating states of the ventilation unit or of the suction device, while the first opening can be open or closed.

The second slide may for example likewise be T-shaped, wherein the upper bar of the preferably T-shaped second slide has a smaller area than the second opening of the ventilation unit. As a result, the upper bar of the second slide can be moved through the second opening of the ventilation unit without closing or coming into contact with the second opening. The lower region of the preferably T-shaped second slide projects preferably into the interior of the ventilation unit and forms the transition to the connecting element. For the purposes of the invention, it is preferred that the first and the second slide are arranged in an axially mirrored manner with respect to one another in the ventilation unit. This preferably means, for the purposes of the invention, that in each case the lower regions of the preferably T-shaped sliding elements project into the interior of the ventilation unit and would meet if they were not separated from one another by the connecting element.

For the purposes of the invention, it is preferred that the second opening of the ventilation unit is closed by the second slide in conjunction with an elastic element at all operating times of the suction device and is closed in the different positions of the active unit, while the first opening of the ventilation unit is exposed by the first slide in the open position of the active unit, such that the ventilation air flow can pass into the interior of the suction device.

For the purposes of the invention, it is preferred that the second slide is designed to close the second opening of the ventilation unit. This closure takes place preferably together with an elastic element, which may be embodied for example as an elastomer membrane. The elastic element can be tensioned over the second sliding element and the second opening and in this way cover or close the second opening of the ventilation unit. In the closed position of the active unit, the elastic element can rest more or less fully on the compensation slide and in this position enclose the volume V with the second slide. A significant advantage of the invention is that the equalization of the pressure can take place in particular independently of the differential pressure in the suction device.

For the purposes of the invention, it is preferred that the second sliding element has a second active surface, which corresponds substantially to a size of an upper bar of the second slide. The pressure equalization that is allowed by the present invention is based preferably on the fact that the forces that act on the sliding elements of the active unit of the ventilation unit are in opposite directions to one another and are substantially identical or similar in size. Preferably, a first force, which, for the purposes of the invention, is preferably also referred to as inlet force F_AE, acts on the first sliding element. In accordance with the spatial directions set out above, it acts in a spatial direction to the right, i.e. from the inlet side of the ventilation unit in the direction of the compensation side of the ventilation unit. The effective directions of the corresponding forces are illustrated by arrows in the drawings. For the purposes of the invention, it is preferred that a second force, which, for the purposes of the invention, is preferably also referred to as compensation force F_AK, acts on the second sliding element. In accordance with the spatial directions set out above, it acts in a spatial direction to the left, i.e. from the compensation side of the ventilation unit in the direction of the inlet side of the ventilation unit. For the purposes of the invention, it is particularly preferred that the forces F_AE and F_AK act in opposite directions to one another and are approximately the same size in terms of magnitude. This is brought about in particular in that a first active surface of the first sliding element and a second active surface of the second sliding element are preferably substantially the same size in the context of the present invention.

For the purposes of the invention, it is preferred that a force F_AE acts on the first active surface and a force F_AK acts on the second active surface, wherein the forces F_AE and F_AK are substantially the same size. Thus, in the context of the present invention, the relationship

$$F\_AE = F\_AK$$

is sought.

For the purposes of the invention, it is preferred that an upper bar of the first sliding element is larger than an upper bar of the second sliding element. Advantageously, this has the result that the first slide is capable of covering and closing the first opening of the ventilation unit, while the second slide can move in and through the second opening. The preferred size ratio between the upper bars of the sliding elements allows the interaction according to the invention of the elements of the ventilation unit, such that an air flow for dedusting a filter can be generated.

In a further aspect, the invention relates to the use of an air flow, which can be conducted into the interior of a suction device using the ventilation unit. As a result, in particular dedusting of a filter of the suction device can be brought about. In yet another aspect, the invention relates to a suction device having at least one ventilation unit, wherein the at least one ventilation unit is designed to generate an air flow for dedusting a filter of the suction device. For the purposes of the invention, it is preferred that a suction device can have for example two, three or four ventilation units, which may be arranged preferably parallel or substantially parallel to one another. For example, each ventilation unit can be assigned to a filter to be dedusted. A particular advantage of the use of a plurality of ventilation units is that continuous operation of the suction device can be allowed. If, for example, a first ventilation unit is in an open position in order to allow the dedusting of a first filter of the suction device, the suction operation of the suction device can be continued with a second ventilation unit. During the dedusting of the first filter, this second ventilation unit is in a closed position, in order to maintain suction operation and the requisite pressure difference between the interior of the suction device and the atmospheric pressure in the environment of the suction device.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

In the figure, the same and similar components are numbered with the same reference signs.

In the figures:

FIG. 1 shows a view of a preferred configuration of the ventilation unit in the closed state or in the closed position of the active unit

FIG. 2 shows a view of a preferred configuration of the ventilation unit in the closed state or in the closed position of the active unit, wherein in particular the active surfaces are illustrated

FIG. 3 shows a view of a preferred configuration of the ventilation unit in the closed state or in the closed position of the active unit, wherein in particular the forces acting on the active surfaces are illustrated

FIG. 4 shows a view of a preferred configuration of the ventilation unit in the open state or in the open position of the active unit, wherein in particular the air flow is illustrated

FIG. 5 shows a view of an alternative preferred configuration of the ventilation unit in the closed state or in the closed position of the active unit

FIG. 6 shows a view of an alternative preferred configuration of the ventilation unit in the closed state or in the closed position of the active unit, wherein in particular the active surfaces are illustrated

FIG. 7 shows a view of an alternative preferred configuration of the ventilation unit in the closed state or in the closed position of the active unit, wherein in particular the forces acting on the active surfaces are illustrated

FIG. 8 shows a view of an alternative preferred configuration of theventilation unit in the open state or in the open position of the active unit, wherein in particular the air flow is illustrated

### DETAILED DESCRIPTION

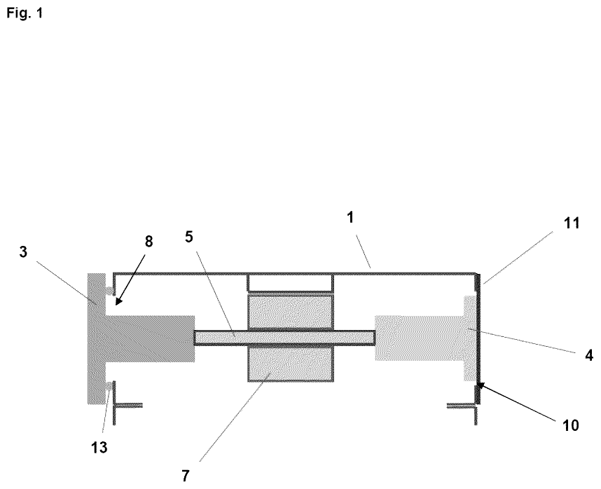

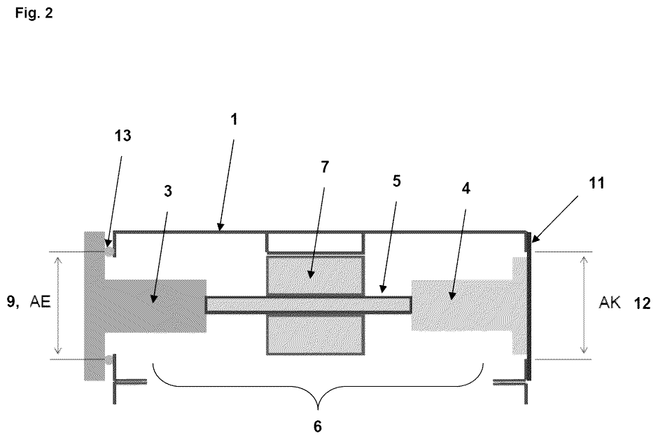

FIG. 1 shows a preferred configuration of the ventilation unit 1 in the closed state or in the closed position of the active unit 6 (see, e.g, FIG. 2). The active unit 6 comprises a first sliding element 3, a second sliding element 4 and a connecting means 5. The connecting means 5 is preferably in the form of a push rod. For the purposes of the invention, it is particularly preferred that the connecting means 5 is rigid and keeps the sliding elements 3, 4 at a constant spacing from one another. Preferably, the first sliding element 3 is designed to close off a first opening 8 of the ventilation unit 1, while the second sliding element 4 is designed to close off a second opening 10 of the ventilation unit 1. Between the first sliding element 3 and an outer side of the housing of the ventilation unit 1, at least one sealing element 13 can be arranged, with which the first opening 8 of the ventilation unit 1 can be closed off in an airtight manner.

For the purposes of the invention, it is preferred that a movement of the connecting means 5 is brought about by an actuator 7. In other words, the connecting means 5 can be moved by the actuator 7. In particular, the actuator 7 can move the connecting means 5, preferably in the form of a push rod, to and fro within the ventilation unit 1, wherein, for the purposes of the invention, this movement of the connecting means 5 is preferably referred to as “lateral movement”. Preferably, the movement, brought about by the actuator 7, of the connecting means 5 causes the entire active unit 6, which comprises the sliding elements 3, 4 and the connecting means 5, to move to and fro within the ventilation unit 1.

For the purposes of the invention, it is preferred that a movement of the active unit 6 in the direction of the first opening 8 is referred to as “movement to the left”, while a movement of the active unit 6 in the direction of the second opening 10 of the ventilation unit 1 is referred to as “movement to the right”. When the active unit 6—as illustrated in FIG. 1—is in the closed position, the first opening 8 of the ventilation unit 1 is closed. The first opening 8 can be opened by the active unit 6 being moved to the left. This opening movement can be brought about for example by the actuator 7 being energized. Alternatively or additionally, the restoring forces of an elastic element 11 can be used in order to move the active unit 6 in an opening movement to the left.

As a result of the active unit 6 being moved to the left, the upper region of the first sliding element 3 is lifted off the first opening 8 such that a gap arises, through which an air flow LS can pass into the interior of the ventilation unit 1. The sliding elements 3, 4 are preferably T-shaped, wherein the upper bar of the preferably T-shaped sliding element 3, 4 is preferably referred to as upper bar of the sliding element 3, 4. As a result of the active unit 6 being moved to the right, the first opening 8 of the ventilation unit can be closed again.

The actuator 7 can preferably be in the form of a lifting magnet, which is in particular an electromagnetic lifting magnet. For the purposes of the invention, it is preferred that an electric current can flow through the actuator 7, with the result that the active unit 6 is then made to move. For the purposes of the invention, it is preferred that a direction of movement of the active unit 6 is dependent on energization or the polarity of the actuator 7.

For the purposes of the invention, it is preferred that the second sliding element 4 of the active unit 6 bears, in its closed position (see FIG. 1), flat against an outer side of the housing of the ventilation unit 1. Preferably, the second sliding element 4 and the elastic element 11 jointly close off the second opening 10 of the ventilation unit 1 by the bearing of the elastic element 11. For the purposes of the invention, it is preferred that the upper bar of the preferably T-shaped second sliding element 4 is smaller than the second opening 10 of the ventilation unit 1. Preferably, atmospheric pressure, for example in the region of 1.013 hPa, prevails on the outer side of the ventilation unit 1. During suction operation of the suction device, a negative pressure prevails in the interior of the ventilation unit 1. Preferably, this negative pressure is generated by a turbine, wherein the turbine can be driven by an electric motor of the suction device. The negative pressure is used during suction operation to suck dust or contaminants into the interior of the suction device, where dust and contaminants can be collected in a dust collecting tank of the suction device. Parts of the dust or contaminants can also enter a filter of the suction device, however, and clog this filter over time. This clogging of the filter is intended to be avoided by regular dedusting of the filter. For this purpose, the suction device can have a ventilation unit 1, which can generate an air flow LS for flushing the filter. For the purposes of the invention, it is very particularly preferred that the air flow LS used for dedusting the filter of the suction device flushes the filter in a direction that is directed counter to the direction of a suction air flow during suction operation of the suction device. This flushing of the filter counter to the suction direction is preferably referred to, for the purposes of the invention, as “backflushing”. For the purposes of the invention, it is very particularly preferred that, with the ventilation unit 1, a backflushing air flow LS can be generated, with which the filter of a suction device can be flushed. To this end, the ventilation unit 1 can be fluidically connected to the interior 2 of the suction device. For example, the interior of the ventilation unit 1 and the interior 2 of the suction device can be connected together such that an exchange of air and pressure between the interiors can take place. This can have the result that, during suction operation of the suction device, a negative pressure can prevail both in the interior of the ventilation unit 1 and in the interior 2 of the suction device, while atmospheric or ambient pressure prevails in the environment of the suction device. As a result of the ventilation unit 1 being opened, pressure equalization between the interior of the ventilation unit 1 or of the suction device and the environment of the suction device can take place, with the result that the air flow LS for dedusting the filter of the suction device can arise. This air flow LS can pass highly dynamically into the interior 2 of the ventilation unit 1 or suction device and flow at high speed through the filter of the suction device. By way of this advantageously rapidly flowing air flow LS, particularly efficient and effective dedusting of the filter of the suction device can be achieved.

FIG. 2 shows a preferred configuration of the ventilation unit 1 in the closed state or in the closed position of the active unit 6, wherein in particular the active surfaces 9, 12 are illustrated. For the purposes of the invention, it is preferred that the size of the active surfaces 9, 12 corresponds substantially to the size of the associated openings 8, 10. This preferably means, for the purposes of the invention, that the first active surface 9 of the first sliding element 3 corresponds substantially to the size of the first opening 8 of the ventilation unit 1. This first active surface 9 is preferably smaller than the area of the upper bar of the preferably T-shaped first sliding element 3. For the purposes of the invention, it is preferred that the second active surface 12 of the second sliding element 4 corresponds substantially to the size of the second opening 10 of the ventilation unit 1. This second active surface 12 is substantially as large as the upper bar of the preferably T-shaped second sliding element 4. For the purposes of the invention, it is preferred that both the sizes of the openings 8, 10 and the two active surfaces 9, 12 are substantially the same size.

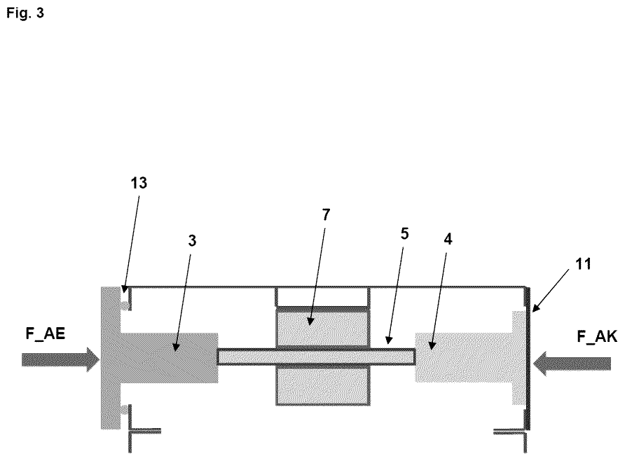

This advantageously has the result that the forces that act on the sliding elements 3, 4 are substantially the same size. These forces F_AK and F_AE are illustrated in FIG. 3. For the purposes of the invention, it is preferred that the force F_AE, which, for the purposes of the invention, can also be referred to as inlet force, acts on the first slide 3. Accordingly, the first slide 3 can preferably also be referred to as inlet slide. Preferably, the compensation force F_AK acts on the second slide 4, wherein the inlet force F_AE acts preferably in a spatial direction to the right while the compensation force F_AK acts preferably in a spatial direction to the left.

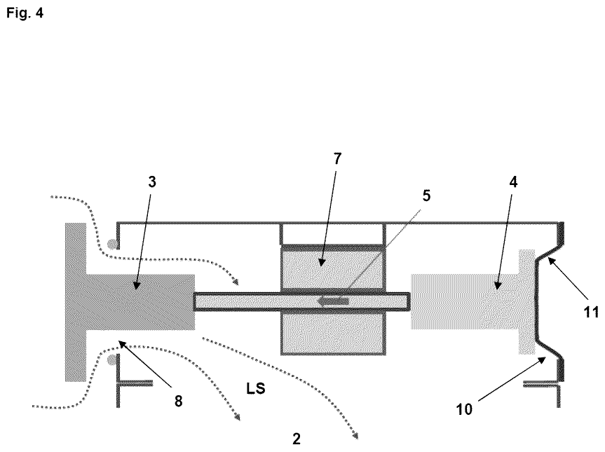

In order to bring the active unit 6 from the closed position, which is illustrated for example in FIGS. 1 to 3, into an open position (see FIG. 4), the inlet force F_AE has to be overcome. This can be done for example with the compensation force F_AK. A significant advantage of the invention is that the ventilation unit 1 is formed with particularly low friction, such that only low energy losses occur during the movement of the connecting means 5 or of the active unit 6. For the purposes of the invention, it is very particularly preferred that the pressure difference between the interior 2 of the suction device or of the ventilation unit 1 and the environment of the suction device can be compensated independently of a differential pressure with regard to atmospheric pressure in the suction device.

FIG. 4 shows a preferred configuration of the ventilation unit 1 in the open state or in the open position of the active unit 6, wherein in particular the air flow LS is illustrated, with which a filter of the suction device can be dedusted or flushed. In the state, illustrated in FIG. 4, of the ventilation unit 1, the first opening 8 of the ventilation unit 1 is open, wherein the first opening 8 is opened in particular by a lateral movement of the active unit 6 in the interior of the ventilation unit 1. For the purposes of the invention, it is very particularly preferred that the first opening 8 of the ventilation unit 1 is opened by the connecting means 5 or the active unit 6 being moved to the left. This takes place in particular in that the upper region of the first sliding element 3 is lifted off the first opening 8 such that a gap arises, through which the dedusting air flow LS can flow into the interior 2 of the ventilation unit 1 or of the suction device. The movement of the active unit 6 to the left in order to open the ventilation unit 1 is indicated in FIG. 4 by the arrow pointing to the left in the interior of the connecting means 5. The dashed arrows in the interior 2 of the suction device or of the ventilation unit 1 indicate the air flow LS and possible courses. In the open position of the active unit 6, the elastic element 11 bulges preferably inwardly into an interior of the ventilation unit 1. The elastic element 11 can be fastened for example to the preferably T-shaped bar of the second sliding element 4, such that the sideways movement of the active unit 6 pulls it inward, i.e. to the left into the interior of the ventilation unit 1.

For the purposes of the invention, it is preferred that the second opening 10 of the ventilation unit 1 is closed both in the closed position and in the open position of the active unit 6. Furthermore, for the purposes of the invention, it is preferred that the ventilation unit 1 can be closed in that the electrical polarity of the actuator 7 is reversed, in particular when it is in the form of an electromagnetic lifting magnet. This preferably means, for the purposes of the invention, that the direction of flow is reversed compared with when the ventilation unit 1 is opened. Thus, the flow flows in an opposite direction through the actuator 7 and the active unit 6 can—rather than to the left in order to open the ventilation unit 1—be used to close it.

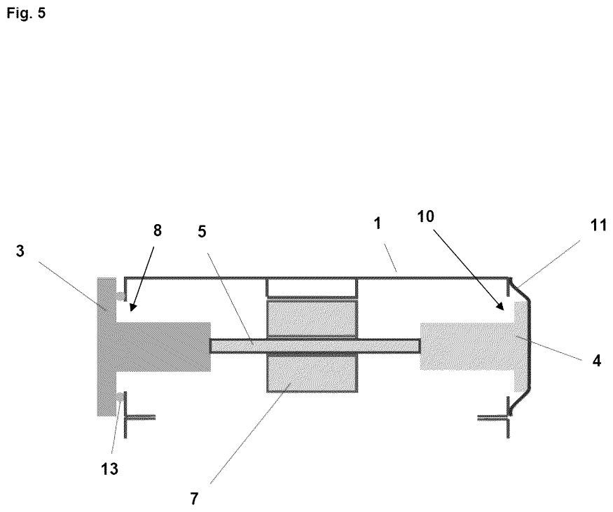

FIG. 5 shows an alternative preferred configuration of the ventilation unit 1 in the closed state or in the closed position of the active unit 6. For the purposes of the invention, it is preferred that the second sliding element 4 of the active unit 6 protrudes, in its closed position in the alternative configuration, illustrated in FIG. 5, of the invention, beyond the housing of the ventilation unit 1. As a result of this protrusion of the second sliding element 4, the elastic element 11 can be stretched. Preferably, the second sliding element 4 and the elastic element 11 jointly close off the second opening 10 of the ventilation unit 1. For the purposes of the invention, it is preferred that the upper bar of the preferably T-shaped second sliding element 4 is smaller than the second opening 10 of the ventilation unit 1, such that the second sliding element 4 can be guided through the second opening 10.

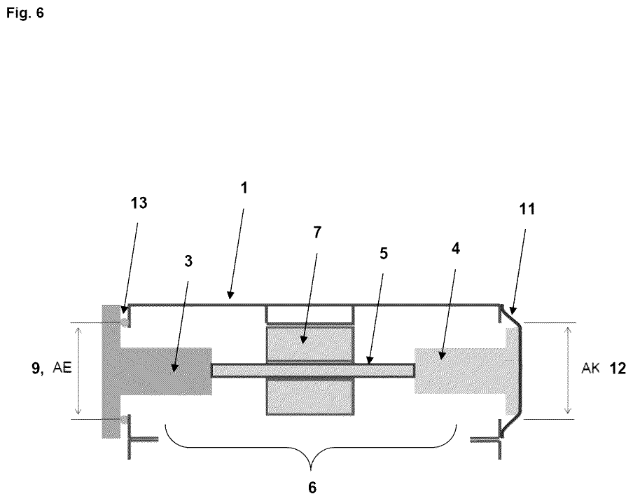

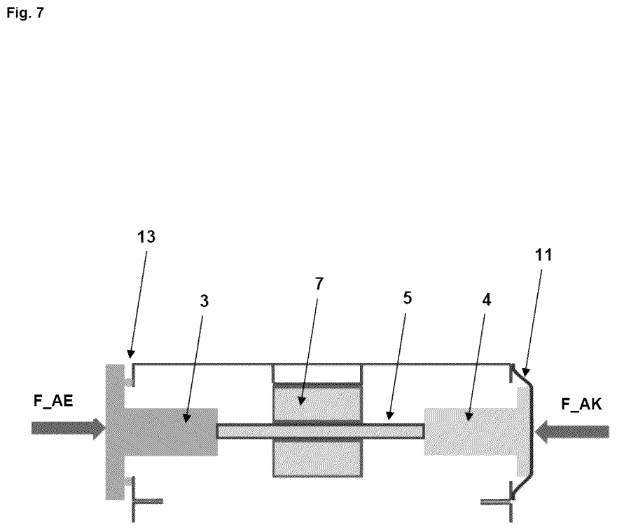

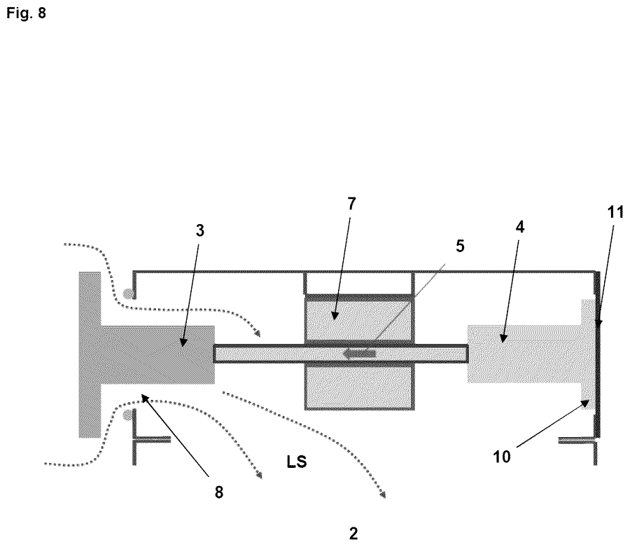

FIG. 6 shows the alternative preferred configuration of the ventilation unit 1 in the closed state or in the closed position of the active unit 6, wherein in particular the active surfaces 9, 12 are illustrated. In order to bring the active unit 6 from the closed position, which is illustrated for example in FIGS. 5 to 7, into an open position (see FIG. 8), the inlet force F_AE has to be overcome.

FIG. 8 shows the alternative configuration of the ventilation unit 1 in the open state or in the open position of the active unit 6, wherein in particular the air flow LS is illustrated, with which a filter of the suction device can be dedusted or flushed. In the state, illustrated in FIG. 8, of the ventilation unit 1, the first opening 8 of the ventilation unit 1 is open, wherein the first opening 8 is opened in particular by a lateral movement of the active unit 6 in the interior of the ventilation unit 1. The movement of the active unit 6 to the left in order to open the ventilation unit 1 is indicated in FIG. 8 by the arrow pointing to the left in the interior of the connecting means 5. The dashed arrows in the interior 2 of the suction device or of the ventilation unit 1 indicate the air flow LS and possible courses.

In this alternative configuration of the invention, the elastic element 11, in the open position of the active unit 6, rests closely, more or less fully, on the outer wall of the ventilation unit 1. The protrusion of the second sliding element 4, which is present when the active unit 6 is in the closed position, is eliminated by the opening of the ventilation unit 1 and is no longer present in the open position of the active unit 6. As a result, the elastic element 11 is no longer stretched, but rather can rest on the outer side of the ventilation unit 1. It is also preferred in the alternative configuration of the invention that the second opening 10 of the ventilation unit 1 is closed both in the closed position and in the open position of the active unit 6.

### LIST OF REFERENCE SIGNS

1 Ventilation unit
2 Interior of a suction device
3 First sliding element
4 Second sliding element
5 Connecting element
6 Active unit
7 Actuator
8 First opening
9 First active surface
10 Second opening
11 Elastic element
12 Second active surface
13 Sealing elements
LS Air flow

1-14. (canceled)

15: A ventilation unit for a suction device, the ventilation unit designed to let an air flow into an interior of the suction device, the ventilation unit comprising:
an actuator; and
a first slide element and a second slide element connected by a connector, wherein the first slide element, the second slide element and the connector form an active unit bringable from a closed position into an open position, and vice versa, by the actuator.

16: The ventilation unit as recited in claim 15 wherein the actuator includes an electromagnetic lifting magnet.

17: The ventilation unit as recited in claim 15 further comprising a first opening closable by the first slide element.

18: The ventilation unit as recited in claim 17 wherein the first slide element has a first active surface corresponding to a size of the first opening.

19: The ventilation unit as recited in claim 17 further comprising seals arranged in the region of the first opening, the seals designed to seal off the first opening (8) of the ventilation unit.

20: The ventilation unit as recited in claim 15 further comprising a second opening.

21: The ventilation unit as recited in claim 15 wherein the second slide element has a second active surface corresponding to a size of an upper bar of the second sliding element.

22: The ventilation unit as recited in claim 15 wherein a first active surface of the first slide element and a second active surface of the second sliding element are a similar size.

23: The ventilation unit as recited in claim 15 wherein a force F_AE acting on a first active surface of the first slide element and a force F_AK acting on a second active surface of the second slide element are similar.

24: The ventilation unit as recited in claim 15 wherein a first upper bar of the first slide element is larger than a second upper bar of the second sliding element.

25: The ventilation unit as recited in claim 15 wherein the connector is rigid or in the form of a push rod.

26: A method for ventilating a suction device with the ventilation unit as recited in claim 15, wherein the method comprising the following steps:
a) providing the suction device having the ventilation unit, the active unit being in a closed position,
b) actuating the actuator such that the active unit is brought into an open position by the actuator,
c) ventilating an interior of the suction device by way of an air flow passing into the interior of the ventilation unit or of the suction device through a first opening exposed by the first slide element.

27: A method for dedusting comprising performing the method of claim 26 to dedust a filter of the suction device.

28: A suction device comprising the ventilation unit as recited in claim 15 designed to generate an air flow for dedusting a filter of the suction device.
